(19) United States
(12) Patent Application Publication
(10) Pub. No.: US 2026/0104946 A1
(43) Pub. Date: Apr. 16, 2026

(54) SYSTEM AND METHOD FOR ALLOCATING RESOURCE BASED ON MULTI-AGENT BASED DEEP REINFORCEMENT LEARNING WITH ATTENTION MECHANISM IN MOBILE EDGE COMPUTING ENVIRONMENT

(71) Applicant: KOREA UNIVERSITY RESEARCH AND BUSINESS FOUNDATION, Seoul (KR)

(72) Inventors: Chung Gu KANG, Seoul (KR); FITSUM DEBEBE TILAHUN, Seoul (KR)

(21) Appl. No.: 19/008,054

(22) Filed: Jan. 2, 2025

(30) Foreign Application Priority Data
Oct. 15, 2024 (KR) 10-2024-0140460

(51) Int. Cl. G06F 9/50; G06F 17/16

(52) U.S. Cl. CPC G06F 9/5094; G06F 17/16

(57) ABSTRACT

The present disclosure relates to a resource allocation technology for a mobile edge computing environment, and more particularly, to a technology of optimizing resource allocation between multiple agents by combining an attention mechanism with a critique network of a deep reinforcement learning model that determines allocation of communication resources or computational resources according to state information.

### CROSS-REFERENCE TO RELATED APPLICATION

This application claims priority under 35 U.S.C § 119 to Korean Patent Application No. 10-2024-0140460 filed in the Korean Intellectual Property Office on Oct. 15, 2024, the entire contents of which are hereby incorporated by reference.

### BACKGROUND OF THE INVENTION

### Field of the Invention

The present disclosure relates to a resource allocation technology for a mobile edge computing environment, and more particularly, to a technology of optimizing resource allocation between multiple agents by combining an attention mechanism with a critique network of a deep reinforcement learning model that determines allocation of communication resources or computational resources according to state information.

Meanwhile, the present disclosure was supported by the following national research development projects.

Subject Identification Code: 1711193094

Grant Number: 2021-0-00467-003

Name of Ministry: Ministry of Science and ICT

Name of Project Management Organization: Institute for Information & communication Technology Planning & evaluation

Research Project Name: 6G Core Technology Development

Research Subject Name: Intelligent 6G Wireless Access System

Name of Project Performing Organization: Korea University Industry-University Cooperation Foundation

Research Period: Jan. 1, 2023 to Dec. 31, 2023

### BACKGROUND OF THE RELATED ART

In a next-generation mobile communication system, cell-free, which is a technology implemented using a distributed antenna system in which multiple antennas are distributed around a user to operate cooperatively without fixed cell boundaries, is emerging as an important technology for providing stable and high-quality communication to a terminal user regardless of his or her location while on the move.

The cell-free technology is likely to be introduced in a next-generation network such as 6G, and a cell-free based network will continue to play an important role in a large-scale antenna system because real-time resource allocation and quality assurance that take user mobility into account are essential. In the large-scale antenna system, multiple antennas operate as a single cluster to simultaneously process each user's data, and its performance is determined by which antennas are used to form the cluster.

Meanwhile, in an advanced communication environment such as 6G, a demand for computing-intensive applications is rapidly increasing, which may result in limitations in processing with the limited resources of a user terminal. In particular, when real-time data processing for applications is required on a user terminal, it becomes difficult to satisfy a strict delay time requirement with only the computing power of the user terminal.

In order to solve the problem, a mobile edge computing method that offloads part of a computational task of the user terminal to an edge server and performs distributed processing the task is being proposed.

In such a mobile edge computing method, it is necessary to divide a task to be performed on the terminal and a task to be transmitted to the edge server, and optimize resource allocation so as to receive a result within a given delay time.

Accordingly, in a mobile edge computing environment, how to efficiently distribute communication resources or computational resources to each terminal determines system performance. In particular, in a large-scale antenna system for cell-free, resource allocation optimization becomes more complex because the configuration of the cluster assigned to each user changes dynamically. For example, when the configuration of the cluster changes constantly as the user moves, a process of updating the optimization of resource allocation in real time is needed. However, such a problem of dynamic resource allocation involves very high computational complexity, and finding optimal resource allocation within a given time is a technically very challenging problem.

A simple resource allocation method to solve the problem is a greedy local approach. In this method, each user processes his or her own task by making maximum use of resources, and only the remaining task is offloaded to the edge server. This method has an advantage of being simple to implement, but has a disadvantage of significantly lowering performance in situations where communication resources and computational resources must be optimized simultaneously.

Therefore, more sophisticated technologies are required to address dynamic optimization of communication and computational resources in a mobile edge computing environment.

### CITATION LIST

### Patent Literature

Korean Patent No. 10-2492716

### Non-Patent Literature

Mnih, V., Kavukcuoglu, K., Silver, D., Rusu, A. A., Veness, J., Bellemare, M. G., . . . & Hassabis, D. (2015). Human-level control through deep reinforcement learning. Nature, 518(7540), 529-533. arXiv preprint arXiv: 1312.5602.
R. Lowe et al., Multi-Agent Actor-Critic for Mixed Cooperative-Competitive Environments, arXiv preprint arXiv: 1706.02275, 2020.

### SUMMARY OF THE INVENTION

An aspect of the present disclosure is to provide a technology that maximizes an efficiency of resource allocation and minimizing energy consumption of a user terminal in a mobile edge computing environment.

Specifically, a problem to be solved by the present disclosure is to provide a resource allocation method that can satisfy delay time constraints while minimizing energy consumption in a situation where the computational task of a user terminal is offloaded to an edge server to support computing-intensive applications.

To this end, the present disclosure proposes a method of performing real-time resource allocation optimization based on deep reinforcement learning (DRL) using a multi-agent deep deterministic policy gradient (MDDPG) algorithm. In particular, the present disclosure applies an attention mechanism to a critique network of a deep reinforcement learning model to achieve efficient resource distribution in consideration of mutual influence between a status and a resource demand of multiple user terminals.

Accordingly, the present disclosure aims to provide a technology that maximizes the performance of a system and realizes optimal resource allocation within a delay time despite user mobility, through a resource allocation method that simultaneously considers communication resources and computational resources in a mobile edge computing environment.

Meanwhile, technical problems of the present disclosure are not limited to the above-mentioned problems, and other technical problems which are not mentioned herein will be clearly understood by those skilled in the art from the description below.

In a resource allocation system based on a multi-agent based deep reinforcement learning model using an attention mechanism in a mobile edge computing environment according to one embodiment, the deep reinforcement learning model may include an actor network learned to determine an action to perform based on state information of the mobile edge computing environment and a critic network learned to determine a Q value representing a total expected value of a reward according to the action, and the system may include a user terminal that operates as a local agent that determines an action in a direction of maximizing a Q value based on state information given based on the actor network and transmits the determined action to an edge server to share with the critic network; and an edge server that derives a Q value according to the action of each user terminal based on the critic network to transmit the derived Q value to each user terminal, wherein the critic network includes an attention layer that generates an output value reflecting a weight according to a similarity between information of any one user terminal and information of another user terminal based on Key, Query, and Value values set according to the attention mechanism, and determines a Q value based on an output value of the attention layer.

Furthermore, the edge server may collect state information on the mobile edge computing environment, generate state information for each user terminal, and transmit the generated state information to each user terminal, and the user terminal may determine an action based on state information acquired from the edge server, and transmit the state information and the determined action information to the edge server to share with all critic networks.

Furthermore, the action may be set to a workload to be allocated to each user terminal according to given state information and uplink transmission power to be allocated to each user terminal according to the given state information, and the reward may be set as a reward in proportion to a total power saving amount of the user terminal.

Furthermore, the edge server may store each critic network that operates in response to each actor network distributed to each user terminal.

Furthermore, an attention layer of a k-th critic network that operates in response to an actor network of a k-th user terminal (k is a natural number greater than or equal to 1 and less than or equal to K), which is any one of K (a total number of user terminals) user terminals, may include Kᵢ(t)=f_{K}(oᵢ(t), aᵢ(t)) which is an encoding function that derives a Key value by other user terminals except the k-th user terminal among the K user terminals (Kᵢ(t) is the Key value, f_{K} is an encoding function that determines the Key value, oᵢ(t) is state information of another user terminal at a t-th time point, and aᵢ(t) is an action of another user terminal at the t-th time point); Qₖ(t)=f_{Q}(oₖ(t), aₖ(t)), which is an encoding function that derives a Query value by the k-th user terminal (Qₖ(t) is the Query value, f_{Q} is an encoding function that determines the Query value, k is k-th state information of the k-th user terminal at the t-th time point, and aₖ(t) is an action of the k-th user terminal at the t-th time point); Vᵢ(t)=f_{V}(oᵢ(t), aᵢ(t)), which is an encoding function that derives a Value value from another user terminal (Vᵢ(t) is the Value value by another user terminal, f_{V} is an encoding function that determines the Value value, oᵢ(t) is state information of another user terminal at the t-th time point, and aᵢ(t) is an action of another user terminal at the t-th time point); and Vₖ(t)=f_{V}(oₖ(t), aₖ(t)), which is an encoding function that derives a Value value by the k-th user terminal (Vₖ(t) is the Value value by the k-th user terminal, is an encoding function that determines the Value value, oₖ(t) is state information of the k-th user terminal at the t-th time point, and aₖ(t) an action of the k-th user terminal at the t-th time point), wherein an output value that reflects a weight according to a similarity between information Qₖ(t) and Vₖ(t) on the k-th user terminal and information Kᵢ(t) and Vᵢ(t) on another user terminal is generated.

Furthermore, the attention layer of the k-th critic network may include a first matrix multiplication layer that derives Qₖ(t)Kᵢ^{T}(t), which is an inner product of the Kᵢ(t) and the Qₖ(t); a scaling layer that derives either one of

$$\frac{{Q}_{k} ( t ) {K}_{i}^{T} ( t )}{\sqrt{{{Q}_{k} ( t ) {K}_{i}^{T} ( t )}^{– – – – – – – – – – – – – –}}} {( {Q}_{k} ( t ) {K}_{i}^{T} ( t )}^{– – – – – – – – – – – – – – –}$$

is a mean value of an inner product of Qₖ(t) and Kᵢ(t)) and

$$\frac{{Q}_{k} ( t ) {K}_{i}^{T} ( t )}{{d}_{inp} \sqrt{d}}$$

(dᵢₙₚ is a size of an outer dimension of a state-action input value or input embeddings represented as a tensor) that scales the

$${Q}_{k} ( t ) {K}_{i}^{T} ( t )$$

by a square root

$$\sqrt{{Q}_{k} ( t ) {K}_{i}^{T} ( t )}$$

of a mean for an inner product of the Kᵢ(t) and the Qₖ(t);
a softmax layer that inputs the normalization value into a softmax function to output either one of

$${α}_{k , t} ( t ) = Softmax ( \frac{{Q}_{k} ( t ) {K}_{i}^{T} ( t )}{\sqrt{{{Q}_{k} ( t ) {K}_{i}^{T} ( t )}^{– – – – – – – – – – – – – –}}} ) and$$

$${α}_{k , t} ( t ) = Softmax ( \frac{{Q}_{k} ( t ) {K}_{i}^{T} ( t )}{{d}_{inp} \sqrt{d}} ) ;$$

a second matrix multiplication layer that derives cₖ, which is an inner product of the α_{k,i} and the Vₖ(t); and a connection layer that generates a concatenated vector acquired by concatenating cₖ and the Vₖ(t) according to a predetermined concatenation algorithm, wherein the critic network determines a Q value, which is a total expected value of a reward according to an action of the k-th user terminal based on the concatenated vector.

Furthermore, the edge server may additionally store an extra actor network for a user terminal to be newly added to its service cluster, and transmit, when there is a user terminal newly added to its service cluster, the extra actor network to the newly added user terminal, and the added user terminal may determine an action in a direction of maximizing a Q value according to state information given from the cluster using the extra actor network.

Furthermore, the edge server may be configured with a main network including a first actor network and a first critic network based on deep reinforcement learning, and a target network including a second actor network and a second critic network having the same neural network structure as the main network to learn the main network and the target network based on a multi-agent deep deterministic policy gradient (MDDPG) learning algorithm through the same learning data, and learn the parameters of the main network and the parameters of the target network at different speeds so as to generate the deep reinforcement learning model.

Furthermore, the edge server may reflect a parameter value of

$${τθ}_{k}^{μ} + ( 1 - τ ) {θ}_{k}^{{μ}^{′}}$$

$${(}_{} {θ}_{k}^{μ}$$

is a learning parameter of the first actor network,

$${θ}_{k}^{{μ}^{′}}$$

is a learning parameter of the second actor network, and τ is a constant that sets an update rate of the two actor network parameters) to the second actor network, and reflect a parameter value of

$${τθ}_{k}^{Q} + ( 1 - τ ) {θ}_{k}^{{Q}^{′}}$$

$${(}_{} {θ}_{k}^{Q}$$

is a learning parameter of the first critic network,

$${θ}_{k}^{{Q}^{′}}$$

is a learning parameter of the second critic network, and τ is a constant that sets an update rate of the two critic network parameters) to the second critic network.

In a method of operating a resource allocation system based on deep reinforcement learning model using an attention mechanism in a mobile edge computing environment according to one embodiment, the deep reinforcement learning model may include an actor network learned to determine an action to perform based on state information of the mobile edge computing environment and a critic network learned to determine a Q value representing a total expected value of a reward according to the action, and the method may include an operation of determining, by the user terminal as a local agent, an action in a direction of maximizing a Q value according to state information given based on the actor network; and an operation of deriving, by the edge server, a Q value according to the action of each user terminal based on the critic network to transmit the derived Q value to each user terminal, wherein the critic network includes an attention layer that generates an output value reflecting a weight according to a similarity between information of any one user terminal and information of another user terminal based on Query, Key, and Value values set according to an attention mechanism, and determines a Q value based on the output value of the attention layer.

The present disclosure may realize resource allocation optimization for implementing cell-free in a mobile edge computing environment, thereby providing an effect of capable of minimizing energy consumption of user terminals and optimizing resource allocation in real time. Through this, a user may maintain stable communication quality while on the move and efficiently process computing tasks while minimizing communication delay.

To this end, a resource allocation method of the present disclosure may be based on deep reinforcement learning (DRL) and a multi-agent deep deterministic policy gradient (MDDPG) algorithm, while applying an attention mechanism thereto to efficiently reflect a status and a resource requirement of each agent, thereby increasing the efficiency of resource distribution as well as maximizing system performance.

Through this, the present disclosure may provide a real-time resource allocation method that can respond to user mobility even in a situation where a plurality of antenna clusters dynamically allocate resources to the user, such as a cell-free based large-scale antenna system.

Such a resource allocation optimization may contribute to improving the user's communication experience and maximizing the resource efficiency of the network, thereby increasing the flexibility of resource allocation under various network conditions and improving the performance of the entire system.

Therefore, the present disclosure may satisfy delay time constraints and energy efficiency required in a next-generation communication system through simultaneous optimization of communication resources and computational resources, and may exhibit very useful technical effects in providing high-quality communication services in a cell-free environment.

Meanwhile, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 is a configuration diagram of a resource allocation system according to one embodiment.

FIG. 2 is a structure of a system that applies a deep reinforcement learning model that does not use an attention mechanism according to one embodiment.

FIG. 3 is a structure of a system to which a deep reinforcement learning model with an attention layer that performs an attention mechanism according to one embodiment is applied.

FIG. 4 is an exemplary diagram for explaining an attention mechanism according to one embodiment.

FIG. 5 is an exemplary diagram for explaining a specific configuration of an attention layer according to one embodiment.

FIG. 6 is an exemplary diagram of a structure for learning a deep reinforcement learning model applied to a resource allocation system according to one embodiment based on an MDDPG algorithm.

FIG. 7 is a configuration diagram of a user terminal and an edge server according to one embodiment.

FIG. 8 is a flowchart showing steps of operations performed by a user terminal and an edge server that constitute a resource allocation system according to one embodiment.

FIG. 9 is a comparison table in which performances according to respective embodiments are compared by applying actual variables of a mobile edge computing environment to a resource allocation system according to various embodiments.

### DETAILED DESCRIPTION OF THE PREFERRED EMBODIMENT

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

Hereinafter, various embodiments of the present disclosure will be described with reference to the accompanying drawings. However, it should be understood that the embodiments are not intended to limit the present disclosure to specific embodiments, and include various modifications, equivalents, and/or alternatives of the embodiments of the present disclosure.

The present disclosure proposes a resource allocation system 10 that applies a model that combines an attention mechanism with a neural network based on deep reinforcement learning (DRL) and multi-agent deep deterministic policy gradient (MDDPG) to a mobile edge computing environment in order to maximize the efficiency of real-time resource allocation and minimize energy consumption in a mobile edge computing environment where part of the computational task of a user terminal (local agent) 100 is offloaded to an edge server 200 to perform distributed processing on the task.

That is, since the resource allocation system 10 of the present disclosure proposes a structure to which a deep reinforcement learning model that combines an attention mechanism with a mobile edge computing environment is applied, variables to be applied to the deep reinforcement learning model such as state information, action, reward, policy, and the like, may be designed as various variables depending on the embodiment.

Meanwhile, since the algorithm itself for deep reinforcement learning is a known technology, general information on terms commonly used in deep reinforcement learning such as state information, action, reward, policy, Q value, policy function, value function, and MDDPG-based learning algorithm may be referred to as “Mnih, V., Kavukcuoglu, K., Silver, D., Rusu, A. A., Veness, J., Bellemare, M. G., . . . & Hassabis, D. (2015). Human-level control through deep reinforcement learning. Nature, 518 (7540), 529-533. arXiv preprint arXiv: 1312.5602.”, “R. Lowe et al., “Multi-Agent Actor-Critic for Mixed Cooperative-Competitive Environments”, arXiv preprint arXiv: 1706.02275, 2020.”

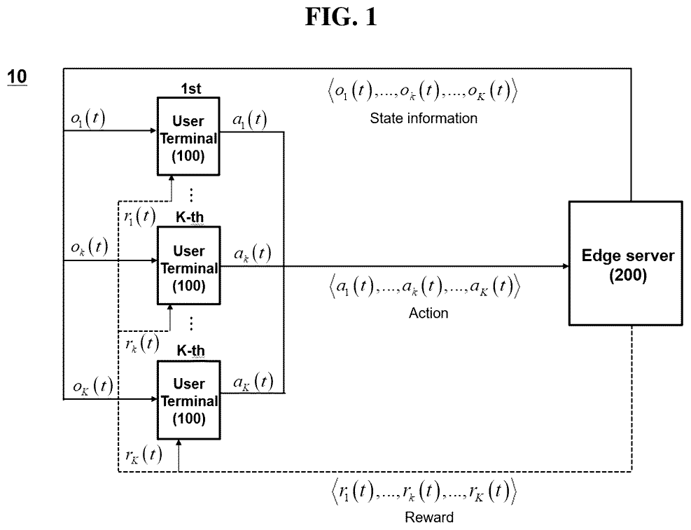

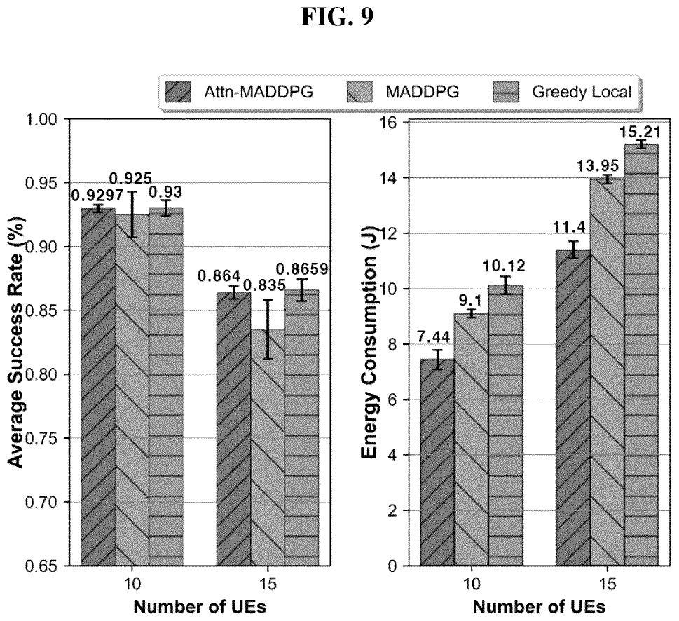

In the detailed description of the present disclosure, a structure in which a deep reinforcement learning model is applied to the resource allocation system 10, and a configuration of the deep reinforcement learning model will be described with reference to FIG. 1 to FIG. 8, and an embodiment in which specific variables of a mobile edge computing environment are applied to the deep reinforcement learning model of the resource allocation system 10 and the performance thereof will be described with reference to FIG. 9.

FIG. 1 is a configuration diagram of a resource allocation system 10 (hereinafter, referred to as a ‘system 10’) according to one embodiment.

Referring to FIG. 1, the system 10 may include one or more user terminals (local agents) 100 and an edge server 200. The system 10 applies an actor network of a deep reinforcement learning model that determines the allocation of communication resources or computational resources based on state information to a user terminal (local agent) 100, and applies a critic network of a deep reinforcement learning model to an edge server 200.

The user terminal (local agent) 100 is a terminal used by a user in a mobile communication system (ex. 5G, 6G, etc.). The user terminal (local agent) 100 may process various tasks requested by the user, and part of a computational task may be offloaded to the edge server 200 to perform distributed processing on the tasks. In this manner, when the user terminal (local agent) 100 performs offloading to perform distributed processing on a task, the user terminal (local agent) 100 may determine communication resources to be used (e.g., selection of transmission power of an uplink for offloading, selection of network bandwidth, etc.) or computational resources to be performed (e.g., a workload to be directly processed, a workload to be transmitted to a server as a distributed task, etc.) using an actor network that performs as a local agent of a reinforcement learning model.

The edge server 200 is a computing device that performs distributed processing on a task requested by the user terminal (local agent) 100 for a cluster area under its service in a mobile communication system (e.g. 5G, 6G, etc.). The edge server 200 may obtain a reward (e.g. a higher reward for lower total power consumption, a higher reward for a shorter task processing delay time, a reward in proportion to a total power saving amount of the user terminal (local agent) 100, etc.) for an action performed by the user terminal (local agent) 100 using a critic network, and improve an efficiency of the entire system 10 by providing feedback to an actor network of the user terminal (local agent) 100 so as to maximize a Q value, which is a total expected value of the reward.

Referring again to FIG. 1, turning to an interaction between the actor network stored in each user terminal (local agent) 100 and the critic network stored in the edge server 200, each user terminal (local agent) 100 (K in total, K is a natural number) receives each state information o₁(t), o₂(t), . . . , o_{K}(t) in a mobile edge computing environment, and determines an optimal action a₁(t), a₂(t), . . . , a_{K}(t) according to each state information using the actor network stored in each user terminal. In this case, each user terminal (local agent) 100 selects an action in a direction of maximizing a Q value through the actor network, and at this time, the action information of each user terminal (local agent) 100 is transmitted to the edge server 200.

The edge server 200 may collect state information (e.g., network bandwidth, packet loss rate, delay time, etc.) for a mobile edge computing environment, and transmit state information corresponding to each user terminal (local agent) 100. The edge server 200 may calculate a reward r₁(t), r₂(t), . . . , r_{K}(t) according to an action of each user terminal (local agent) 100 based on the action determined by the user terminal (local agent) 100. In this case, the edge server 200 may calculate a reward and Q value according to an action of each user terminal (local agent) 100 through the critic network, and provide feedback information on the reward and Q value to each user terminal (local agent) 100, thereby optimizing the resource allocation of the entire system 10.

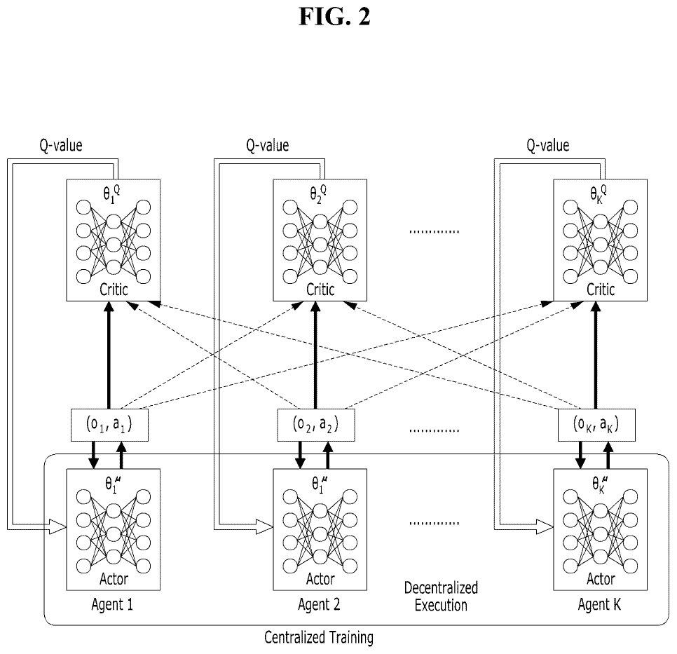

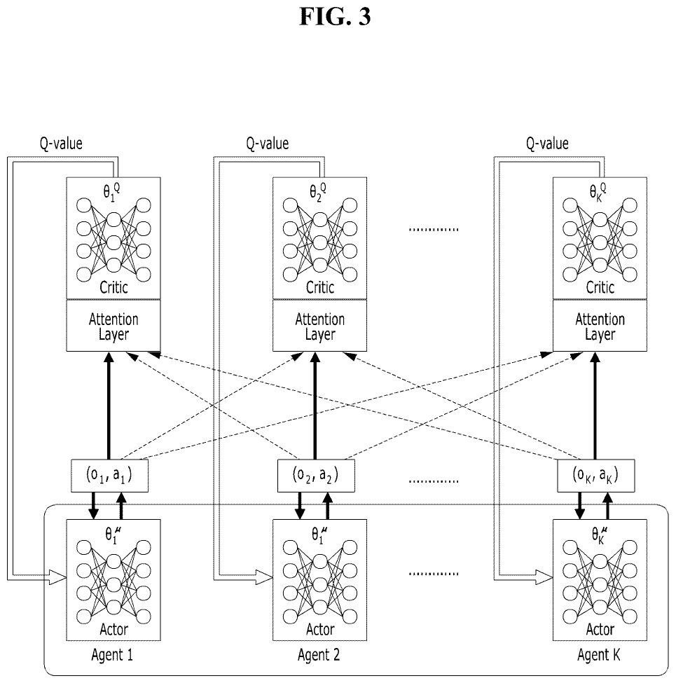

Meanwhile, if FIG. 1 is a view of the structure from the perspective of the user terminal (local agent) 100 and the edge server 200 that constitute the system 10 according to one embodiment, then the structure from the perspective of a deep reinforcement learning model applied by the system 10 is as shown below in FIG. 2 or FIG. 3.

FIG. 2 is a structure of the system 10 that applies a deep reinforcement learning model that does not use an attention mechanism according to one embodiment.

Referring to FIG. 2,

$$( {θ}_{k}^{μ} , {θ}_{k}^{Q} )$$

are respective parameters of the actor network and the critic network of the k-th user agent.

The parameter

$${θ}_{k}^{μ}$$

of the actor network corresponds to a parameter that determines an action aₖ by taking the state information (oₖ, rₖ) of the k-th user terminal (local agent) 100 as input, and the actor network determines an action according to a policy function

$${μ}_{k} ( {o}_{k} \vert {θ}_{k}^{μ} )$$

defined based on the parameter θₖ^{μ}.

The parameter

$${θ}_{k}^{Q}$$

of the critic network corresponds to a parameter that determines a reward rₖ and Q value for the k-th user terminal (local agent) 100 by taking an action (a₁, a₂, . . . , a_{K}) taken by all user terminals (local agents) 100 as input, and the critic network determines the reward rₖ and Q value according to a value function

$${Q}_{k} ( {s}_{k} , a \vert {θ}_{k}^{Q} )$$

defined based on the parameter

$${θ}_{k}^{Q} .$$

As an example, the actor network and the critic network may be designed as a deep neural network structure, and the parameters of those neural networks may be learned by a deep reinforcement learning algorithm. To this end, the edge server 200 may learn the actor network and the critic network by defining state information, an action, a reward, a policy, a Q value, a policy function, a value function, and a loss function, and distribute the actor network for which learning is complete to each user terminal (local agent) 100. Accordingly, each user terminal (local agent) 100 may store the actor network, and the edge server 200 may store the critic network corresponding to each actor network. That is, from the perspective of any one user terminal (local agent) 100, the actor network assigned to itself is stored by itself, and the critic network interacting with the actor network that is stored by itself is stored by the edge server 200.

Meanwhile, according to the structure of the system 10 that applies a deep reinforcement learning model to which the attention mechanism of FIG. 2 is not applied, the critic network collects the actions and state information of all agents to calculate a Q value, wherein the critic network calculates the Q value by collecting the state information and action of each agent as input values without distinguishing them so as not to reflect a relative influence between each user terminal (local agent) 100, and thus the contribution of each agent is applied equally.

However, in an actual environment, the information of each user terminal (local agent) 100 may not have the same impact on the system 10. For example, since resource allocation to a specific user terminal (local agent) 100 may have a greater impact on the performance of the entire system 10 depending on the situation, reflecting the importance of each agent differently may increase the efficiency of the entire system 10.

Taking such a point into consideration, the following embodiment of FIG. 3 shows a deep reinforcement learning model with an added attention layer generating an output value that reflects a weight according to a similarity between information of any one user terminal (local agent) 100 and information of another user terminal (local agent) 100.

FIG. 3 is a structure of the system 10 to which a deep reinforcement learning model with an attention layer that performs an attention mechanism according to one embodiment is applied.

Referring to FIG. 3, the critic network may further include an attention layer, and the attention layer may receive state information and an action of each user terminal (local agent) 100 as input, and generate an output value that is weighted by considering an interaction between each agent based on a Query, a Key, and a Value through an attention mechanism. Accordingly, the system 10 of FIG. 3 reflects that a specific agent may have a different impact on the performance of the entire system 10 according to resource allocation, and when any one agent has a more important impact than another agent, the attention layer calculates a Q value by reflecting the information of the corresponding agent with a higher weight.

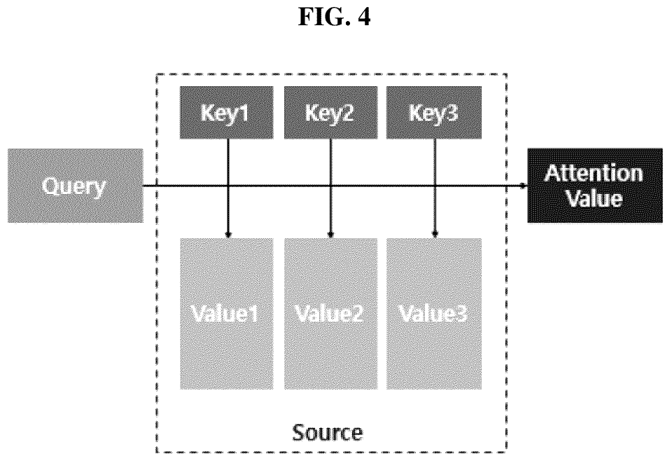

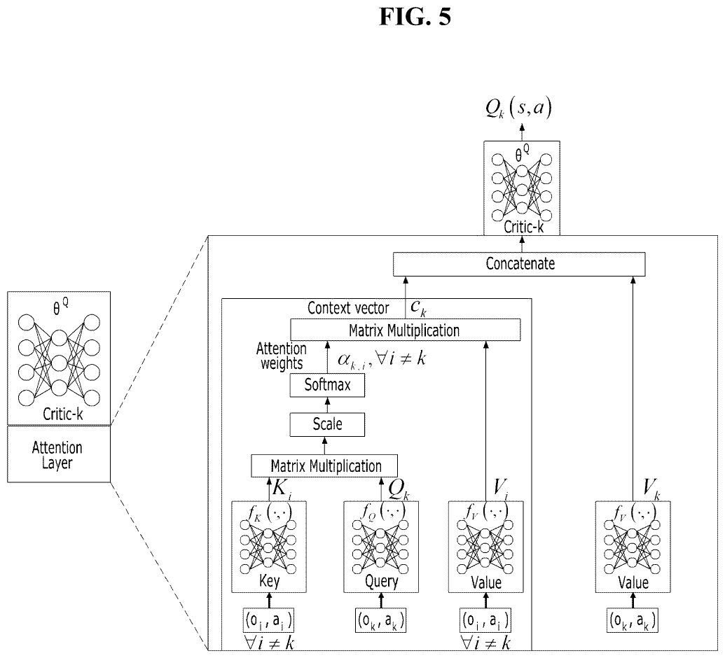

An embodiment of an application of an attention layer that performs the attention mechanism is shown in the following FIGS. 4 and 5.

FIG. 4 is an exemplary diagram for explaining an attention mechanism according to one embodiment. An attention mechanism used in the present disclosure refers to an algorithm of the attention mechanism used in a transformer model, and the present disclosure proposes a new structure that applies the attention mechanism proposed in the transformer model to deep reinforcement learning.

Referring to FIG. 4, a Query, a Key, and a Value are elements that perform an attention mechanism. The Query may be set to a vector representing a target to be noted in the current system 10, the Key may be set to a vector representing the characteristics of target objects to be noted, and the Value may be set to actual information corresponding to each Key.

When a Query value is given, the attention mechanism calculates a similarity to each key based on the Query value. The similarity calculated in this manner is reflected in a Value connected to each Key. That is, a Value connected to a Key with a high similarity is reflected as more important, and a Value connected to a Key with a low similarity is processed as less important. Accordingly, the attention mechanism weights all Value values according to their similarity, and then adds the weighted Value values to output a final Attention value.

Therefore, in the system 10 of the present disclosure, the attention mechanism may operate in a manner of adjusting ‘resource allocation information of each user terminal’ as a ‘Value,’ based on a similarity between ‘state information and an action of a specific user terminal (local agent) 100’ as a ‘Query’ and ‘state information and an action of other user terminals (local agents) 100’ as a ‘Key’, and ultimately focusing more on information of a more important user terminal (local agent) 100. An attention layer that implements an attention mechanism according to this embodiment is as shown in FIG. 5.

FIG. 5 is an exemplary diagram for explaining a specific configuration of an attention layer according to one embodiment. FIG. 5 shows an attention layer of a k-th critic network that operates in response to an actor network of a k-th user terminal (local agent) 100 (k is a natural number greater than or equal to 1 and less than or equal to K) among K user terminals (local agents) 100 (a total number of user terminals (local agents) 100).

Referring to FIG. 5, the attention layer determines weights based on a similarity to the data values of other user terminals (local agents) 100 for the data value of each user terminal (local agent) 100, and calculates an Attention value using the weights. In order to calculate the weighted average therefor, the attention weight of an i-th (i≠k) user terminal (local agent) 100 with respect to the k-th (k is a natural number greater than or equal to 1 and less than or equal to K) user terminal (local agent) 100 is referred to as α_{k,i}(t). In this case, Query, Key, Value values according to the state information and an action at a time point t of the i-th user terminal (local agent) 100 are determined by respective encoding functions (=configured with neural networks) f_{Q}(⋅, ⋅), f_{K}(⋅, ⋅), and f_{V}(⋅, ⋅). In this case, each encoding function may be implemented as a fully connected neural network having d outputs (d is a dimension of an output vector) and one or more intermediate layers.

As an example, the attention layer may include an encoding function Kᵢ(t)=f_{K}(oᵢ(f), aᵢ(t)) (Kᵢ(t) is a Key value, f_{K} is an encoding function that determines the Key value, oᵢ(t); is state information of another user terminal (local agent) 100 at a t-th time point, and aᵢ(t) is an action of another user terminal (local agent) 100 at the t-th time point) that derives the Key value by the other user terminals (local agents) 100 (hereinafter, referred to as ‘other user terminals (local agents) 100’) except for the k-th user terminal (local agent) 100 among K user terminals (local agents) 100.

As an example, the attention layer may include an encoding function Qₖ(t)=f_{Q}(oₖ(t), aₖ(t)) (Qₖ(t) is a Key value, f_{Q} is an encoding function that determines the Query value, oₖ(t) is the k-th state information of the k-th user terminal (local agent) 100 at the t-th time point, and aₖ(t) is an action of the k-th user terminal (local agent) 100 at the t-th time point) that derives the Query value by the k-th user terminal (local agent) 100.

As an example, the attention layer may include an encoding function Vᵢ(t)=f_{V}(oᵢ(t), aᵢ(t)) (Vᵢ(t) is a Value value by another user terminal (local agent) 100, f_{V} is an encoding function that determines the Value value, oᵢ(t) is state information of another user terminal (local agent) 100 at the t-th time point, and aᵢ(t) is an action of another user terminal (local agent) 100 at the t-th time point) that derives the Value value by another user terminal (local agent) 100.

As an example, the attention layer may include an encoding function Vₖ(t)=f_{V}(oᵢ(t), aₖ(t)) (Vᵢ(t) is a Value value by the k-th user terminal (local agent) 100, f_{V} is an encoding function that determines the Value value, oₖ(t) is state information of the k-th user terminal (local agent) 100 at the t-th time point, and aₖ(t) is an action of the k-th user terminal (local agent) 100 at the t-th time point) that derives the Value value by the k-th user terminal (local agent) 100.

Specifically, the attention layer may include the following detailed layers.

As an example, the attention layer may include a first matrix multiplication layer (lower matrix multiplication block in FIG. 5) that derives

$${Q}_{k} ( t ) {K}_{i}^{T} ( t ) ,$$

which is an inner product of Kᵢ(t) and Qₖ(t).

As an example, the attention layer may include a scaling layer (scale block in FIG. 5) that derives

$$\frac{{Q}_{k} ( t ) {K}_{i}^{T} ( t )}{\sqrt{{{Q}_{k} ( t ) {K}_{i}^{T} ( t )}^{∼ ∼ ∼ ∼ ∼ ∼ ∼ ∼ ∼ ∼ ∼ ∼ ∼}}} {{(}_{} {Q}_{k} ( t ) {K}_{i}^{T} ( t )}^{-- -- -- -- -- -- -}$$

is a mean value of an inner products of Qₖ(t) and Kᵢ(t)) scaled by

$${Q}_{k} ( t ) {K}_{i}^{T} ( t )$$

by a square root

$$\sqrt{{{Q}_{k} ( t ) {K}_{i}^{T} ( t )}^{-- -- -- -- -- -- -}}$$

of a mean of an inner product of Kᵢ(t) and Qₖ(t). Meanwhile, the scaling layer may also derive

$$\frac{{Q}_{k} ( t ) {K}_{i}^{T} ( t )}{\sqrt{d}}$$

that scales an inner product of Kᵢ(t) and Qₖ(t) into

$${Q}_{k} ( t ) {K}_{i}^{T} ( t )$$

by \sqrt{d} (here, d represents a size of an outer axis of Qₖ given as a tensor).

Meanwhile, when scaling an inner product of Query and Key values, there is a problem in that an input value of softmax becomes too small or too large depending on an initial value set to a certain value, and thus, scaling by

$$\sqrt{{Q}_{k} ( t ) {K}_{i}^{T} ( t )} ,$$

which is a root mean square (RMS) value for an inner product of the Query and Key values, has an advantage of solving the problem.

As an example, the attention layer may include a softmax layer (softmax block in FIG. 5) that inputs a normalized value into a softmax function and outputs

$${α}_{k , i} ( t ) = Softmax ( \frac{{Q}_{k} ( t ) {K}_{i}^{T} ( t )}{\sqrt{{Q}_{k} ( t ) {K}_{i}^{T} ( t )}} ) .$$

If scaled with \sqrt{d}, then

$${α}_{k , i} ( t ) = Softmax ( \frac{{Q}_{k} ( t ) {K}_{i}^{T} ( t )}{\sqrt{d}} ) .$$

may be output.

In addition, as a method of resolving instability due to the dispersion of state-action input or input embedding, regularization may be modified as follows:

$${α}_{k , i} ( t ) = Softmax ( \frac{{Q}_{k} ( t ) {K}_{i}^{T} ( t )}{{d}_{inp} \sqrt{d}} )$$

Here, dᵢₙₚ represents a state-action input value represented as a tensor or a size of an outer dimension of input embedding.

As an example, the attention layer may include a second matrix multiplication layer (upper matrix multiplication block in FIG. 5) that derives cₖ, which is an inner product of α_{k,i}(t) and Vᵢ(t).

As an example, the attention layer may include a connection layer (a concatenate block in FIG. 5) that generates a concatenated vector acquired by concatenating cₖ and Vₖ(t) according to a predetermined concatenation algorithm. For example, the connection layer may generate a concatenated vector acquired by concatenating cₖ and Vₖ(t) based on at least one technique of concatenation, addition, averaging, and gate network.

Accordingly, the attention layer may generate an output value that reflects a weight according to a similarity between the information Qₖ(t) and Vₖ(t) of the k-th user terminal (local agent) 100 and the information Kᵢ(t) and Vᵢ(t) of another user terminal (local agent) 100 by using a value according to the encoding function and the foregoing detailed layers.

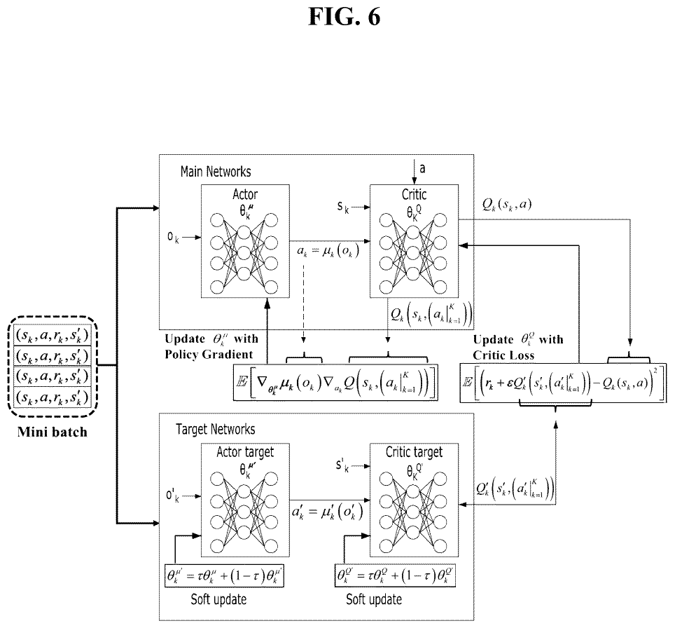

Accordingly, according to the system 10 of FIG. 5, the attention mechanism may determine a reward Qₖ(s,a) from an output value by adjusting the resource allocation information (Value) of each agent based on a similarity between the state information and action (Query) of a specific user terminal (local agent) 100 and the state information and action (Key) of other user terminals (local agents) 100, so as to improve the efficiency of the entire system 10 by ultimately focusing on the information of the more important user terminal (local agent) 100. An embodiment in FIG. 6 may be applied to real-time learning of the foregoing deep reinforcement learning model in FIG. 2 or FIG. 3.

Meanwhile, the edge server 200 may additionally store an extra actor network for the user terminal (local agent) 100 that is newly added to its service cluster. Accordingly, the edge server 200 may transmit, when there is the user terminal (local agent) 100 to be newly added to its service environment, an extra actor network to the newly added user terminal (local agent) 100. Accordingly, the user terminal (local agent) 100 newly added to the cluster may immediately determine an action in a direction of maximizing a Q value based on state information given from the cluster by using the extra actor network.

FIG. 6 is an exemplary diagram of a structure for learning a deep reinforcement learning model applied to the system 10 according to one embodiment based on a multi-agent deep deterministic policy gradient (MDDPG) algorithm.

In order to learning parameters of the actor network and the critic network in the deep reinforcement learning model, the MDDPG algorithm performs learning by dividing a main network including a first actor network and a first critic network, and a target network including a second actor network and a second critic network.

The main network is a network that determines an optimal action from a current state through learning. The first actor network of the main network determines an optimal action (policy) to perform in a given state, and the first critic network predicts a Q value for a given state and action pair.

The main network and the target network are both stored in the edge server 200 during learning, learning is performed in the edge server 200, and subsequent to learning, the actor network may be distributed to the user terminal (local agent) 100.

The target network obtains samples from an experience replay in each learning step to carry out learning, which are used in a process of continuously updating the weights of the target network. The target network is used to help the main network learn stably. If the weights of the network is continuously updated while learning on the main network is carried out, then the learning process may become unstable. In order to alleviate the problem, a target network with the same structure as the main network but updated slowly is used, and the target network may update the weights of the main network at regular intervals.

To this end, the target network may delay the parameters of the main network to generate each copy value

$${θ}_{k}^{{μ}^{′}} and {θ}_{k}^{{Q}^{′}} .$$

For example,

$${θ}_{k}^{{μ}^{′}}$$

may be lazily updated according to

$${θ}_{k}^{{μ}^{′}} ← {τθ}_{k}^{μ} + ( 1 - τ ) {θ}_{k}^{{μ}^{′}}$$

$$( {θ}_{k}^{μ}$$

is a parameter of the first actor network learned at a time point t,

$${θ}_{k}^{{μ}^{′}}$$

on the right is a parameter of the second actor network learned at a time point t, and τ is a constant that sets a parameter update rate of the left second actor network).

$${θ}_{k}^{{Q}^{′}}$$

may be lazily updated according to

$${θ}_{k}^{{Q}^{′}} ← {τθ}_{k}^{Q} + ( 1 - τ ) {θ}_{k}^{{Q}^{′}}$$

$$( {θ}_{k}^{Q}$$

is a parameter of the first critic network learned at a time point t,

$${θ}_{k}^{{Q}^{′}}$$

on the right is a parameter of the second critic network learned at a time point t, and τ is a constant that sets a parameter update rate of the left second critic network).

Due to this, the second critic network may be used for Q-learning update, the second actor network may be updated by the second critic network, and the target network may maintain a stable Q value despite a rapid change in the main network.

Since the learning of the main network and the target network may be performed in non-real-time, each agent may utilize additional global information, and thus each agent may learn by using all actions selected by other agents, including itself. That is, at a time point t of the training process, all agents use a(t)=(a₁(t), a₂(t), . . . , a_{K}(t)) Additionally, the agent may use not only state information oₖ(t) on its own environment, but also state information o₋ₖ(t) on other agents. That is, a network condition during the training process may be given as sₖ(t)=(oₖ(t), o₋ₖ(t)).

Meanwhile, after the training process is completed, each agent may operate in a fully distributed manner during an inference execution phase. That is, during the execution process, all global information acquired during a central training process is discarded, and only state information oₖ(t), which is local information that can be acquired at a current time point t, is used to determine an action aₖ(t).

The first actor network maps a value of oₖ(t) observed by itself to

$${μ}_{k} ( {o}_{k} ( t ) \vert {θ}_{k}^{μ} ) .$$

In this case, a random noise Nₖ(t) is generated and added to reflect a search policy, thus becoming

$${a}_{k} ( t ) = {μ}_{k} ( {o}_{k} ( t ) \vert {θ}_{k}^{μ} ) + {N}_{k} ( t ) .$$

The action values a(t)={aₖ(t), ∀ₖ∈K} are shared among all agents, and the reward value rₖ(t) and the subsequent state information value oₖ(t+1) are transmitted to each k-th agent. Then, the agent stores eₖ(t)=(sₖ(t), a(t), rₖ(t), sₖ(t+1)) in a replay buffer Dₖ, and samples those values to construct a loss function. For example, if each i-th sample in eₖ(t)=(sₖ(t), a(t), rₖ(t), sₖ(t+1)) is

$${s}_{k}^{i} , {a}^{i} , {r}_{k}^{i} , {s}_{k}^{i + 1} ,$$

then B samples

$${( {s}_{k}^{i} , {a}^{i} , {r}_{k}^{i} , {s}_{k}^{i + 1} ) \vert}_{i = 1}^{B}$$

may be randomly selected to construct a mini batch. In this case, an i-th target value

$${y}_{k}^{i}$$

may be updated to

$${{y}_{k}^{i} = {r}_{k}^{i} + ε {Q}_{k}^{′} ( {s}_{k}^{i + 1} , {a}_{i + 1} \vert {θ}_{k}^{{Q}^{′}} ) \vert}_{{a}_{i + 1} = \{ {μ}_{k}^{′} ( {o}_{k}^{i + 1} ) , ∀ k ∈ K \}}$$

by applying a discount rate ε, and the loss function may be calculated based on the value as follows.

$${L}_{k} ( {θ}_{k}^{Q} ) = \frac{1}{B} {\sum }_{i} {( {y}_{k}^{i} - {Q}_{k} ( {s}_{k}^{i} , {a}^{i} \vert {θ}_{k}^{Q} ) )}^{2} \qquad [ Equation 1 ]$$

The parameter

$$\{ {θ}_{k}^{Q} \}$$

of the first critic network is updated to

$${θ}_{k}^{Q} ← {θ}_{k}^{Q} - {β}_{Q} {∇}_{{θ}_{k}^{Q}} {L}_{k} ( {θ}_{k}^{Q} )$$

according to a gradient of the above loss function, where β_{Q} represents a learning rate required for parameter update of the first critic network. Likewise, the first critical network updates the parameter to

$${θ}_{k}^{μ} ← {θ}_{k}^{μ} - {β}_{μ} {∇}_{{θ}_{k}^{μ}} J ( {μ}_{k} \vert {θ}_{k}^{μ} )$$

to maximize an expected reward

$$J ( {μ}_{k} \vert {θ}_{k}^{μ} )$$

with the discount rate applied in a long run, where

$${∇}_{{θ}_{k}^{Q}} J ( {μ}_{k} \vert {θ}_{k}^{μ} )$$

represents a deterministic policy gradient given as follows.

$${∇}_{{θ}_{k}^{μ}} J ( {μ}_{k} \vert {θ}_{k}^{μ} ) \approx \frac{1}{B} [ {\sum }_{i} {∇}_{{a}_{k}} {Q}_{k} ( {s}_{k}^{i} , {a}_{i} \vert {θ}_{k}^{Q} ) {∇}_{{θ}_{k}^{μ}} {μ}_{k} ( {o}_{k}^{i} \vert {θ}_{k}^{μ} ) ] {\vert}_{{a}_{i} = \{ {μ}_{k} ( {o}_{k}^{i} ) , ∀ k ∈ K \}} \qquad [ Equation 2 ]$$

Here, β_{μ} represents a learning rate of the first actor network.

Accordingly, the target parameters of the second actor network and the second critic network may be soft updated to

$${θ}_{k}^{{μ}^{′}} ← {τθ}_{k}^{μ} + ( 1 - τ ) {θ}_{k}^{{μ}^{′}} and {θ}_{k}^{{Q}^{′}} ← {τθ}_{k}^{Q} + ( 1 - τ ) {θ}_{k}^{{Q}^{′}}$$

using a very small constant value τ.

In this way, as four different networks interact with one another when training each agent via the MDDPG algorithm, training may be carried out over multiple episodes to reflect a mutual influence between all agents for resource allocation, and each episode may consist of multiple consecutive time points.

In this case, a loss of the k-th agent in the critic network of the attention mechanism may be represented as

$${L}_{k}^{critic} ( {θ}_{k}^{Q} ) , where {L}_{k}^{critic} ( {θ}_{k}^{Q} )$$

is given as follows through the samples of a replay buffer.

$${L}_{k}^{crtitc} ( {θ}_{k}^{Q} ) = \frac{1}{B} {\sum }_{i} {( {y}_{k}^{i} - {Q}_{k} ( {s}_{k}^{i} , {a}^{i} \vert {θ}_{k}^{Q} ) )}^{2} \qquad [ Equation 3 ]$$

In addition, the loss function for training the critic network that shares information between all user terminals (local agents) 100 is L^{critic}, where L^{critic} is given as an average value for critic network loss values of all agents as follows:

$${L}^{critic} = \frac{1}{K} {\sum }_{k} {L}_{k}^{critic} ( {θ}_{k}^{Q} ) \qquad [ Equation 4 ]$$

In addition, the loss of the k-th actor network is

$${L}_{k}^{actor} ( {θ}_{k}^{Q} ) ,$$

which is computed by sampling a state transition as follows:

$${{L}_{k}^{actor} = - \frac{1}{B} [ {Q}_{k} ( s , {a}_{1} , … , {a}_{K} ) ] \vert}_{{a}_{i} = \{ {μ}_{k} ( {o}_{k}^{i} ) , ∀ k ∈ K \}} \qquad [ Equation 5 ]$$

Additionally, the loss function for training the actor network that shares information between all agents is L^{actor}, where L^{actor} is given as an average value of all actor network losses as follows:

$${L}^{actor} = \frac{1}{K} {\sum }_{k} {L}_{k}^{actor} \qquad [ Equation 6 ]$$

An embodiment of the foregoing learning method of FIG. 6 is merely an example, and the learning method of the deep reinforcement learning model applied to the system 10 of the present disclosure is not limited to the method of FIG. 6. That is, various learning techniques as well as the embodiment of FIG. 6 may be applied to the structure of the deep reinforcement learning model described through FIGS. 1 to 5 to perform learning.

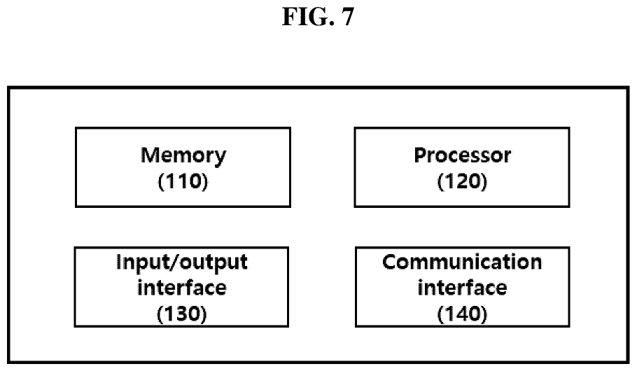

Meanwhile, a specific configuration of the user terminal (local agent) 100 and the edge server 200 in the system 10 according to the embodiment of the present disclosure is as shown below in FIG. 7.

FIG. 7 is a configuration diagram of the user terminal (local agent) 100 and the edge server 200 according to one embodiment.

Referring to FIG. 7, the user terminal (local agent) 100 and the edge server 200 according to one embodiment may each include a memory 110, a processor 120, an input/output interface 130, and a communication interface 140.

The memory 110 may store data acquired from an external apparatus or data generated by itself. The memory 110 may store instructions that can perform an operation of the processor 120. For example, the memory of the user terminal (local agent) 100 may store an actor network. For example, the memory of the edge server 200 may store a critic network. Additionally, the memory of the edge server 200 may store the main network and the target network described during the learning of FIG. 6.

The processor 120 is an operational apparatus that controls an overall operation. The processor 120 may execute instructions stored in the memory 110. The operation of the user terminal (local agent) 100 and the edge server 200 according to an embodiment of the present disclosure will be understood as an operation performed by the processor 120.

The input/output interface 130 may include a hardware interface or software interface that inputs and outputs information.

The communication interface 140 allows information to be transmitted and received through a communication network. To this end, the communication interface 140 may include a wireless communication module or a wired communication module.

The user terminal (local agent) 100 and the edge server 200 may be implemented as various types of apparatuses capable of performing operations through the processor 120 and transmitting and receiving information through a network. For example, it may be implemented in a form of a computer device, a portable communication apparatus, a smart phone, a portable multimedia apparatus, a laptop, a tablet PC, and the like, but is not limited to those examples.

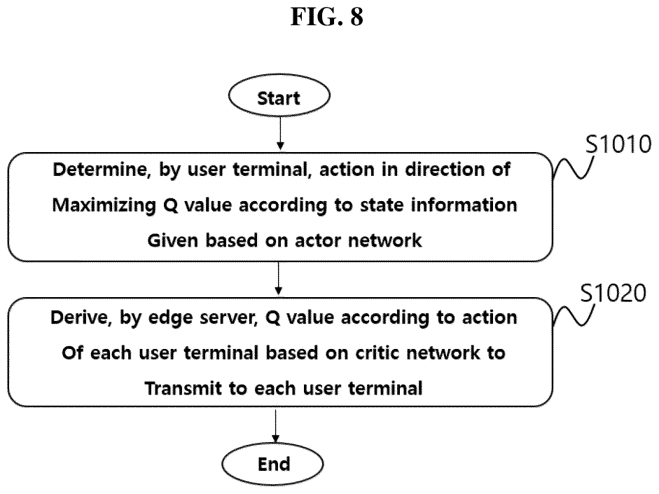

FIG. 8 is a flowchart showing steps of operations performed by the user terminal (local agent) 100 and the edge server 200 that constitute the system 10 according to one embodiment. The operation of the user terminal (local agent) 100 and the edge server 200 that is configured according to an embodiment in FIG. 8 will be understood as an operation performed by the processor 120.

Each step disclosed in FIG. 8 is only a preferred embodiment in achieving the objectives of the present disclosure, and some steps may be added thereto or deleted therefrom as needed, and any one step may be included in another step to be performed. The order of respective operations disclosed in FIG. 8 is only arranged for convenience of understanding, and such an order is not limited to a time series order, and the order may be changed and operated differently depending on the designer's choice.

Referring to FIG. 8, in step S1010, the user terminal (local agent) 100 may determine an action in a direction of maximizing a Q value according to state information given based on an actor network.

In step S1020, the edge server 200 may derive a Q value according to an action of each user terminal (local agent) 100 based on a critic network and transmit the derived Q value to each user terminal (local agent) 100.

Meanwhile, the description of the actor network and critic network interacting according to the operation of FIG. 8 has been described together with FIGS. 1 to 7, and thus a redundant description thereof will be omitted.

FIG. 9 is a comparison table in which performances according to respective embodiments are compared by applying actual variables of a mobile edge computing environment to a resource allocation system according to various embodiments. Prior to describing a performance according to an experiment in FIG. 9, variables and system settings applied to the experiment are first described.

In order to implement the large-scale antenna system 10 for cell-free, the experiment of FIG. 9 has set variables in consideration of computing resources required for calculation and a model of the system 10 required for transmission power allocation of the terminal. The definitions of symbols used in environment settings, which will be described later, are as follows.

| Sign | Definition |
|---|---|
| M = {1, 2, ... , M } | A set of indices each representing M access |
| | points (APs) |
| K ={1,2, ... , K} | A set of indices each representing K users |
| C^{max} | A maximum number of APs that constitute |
| | a cluster (C^{max} ≤ M) |
| Nₖ | A number of APs belonging to a cluster that |
| | supports a k-th user (Nₖ ≤ C^{max}) |
| ${AP}_{n}^{( k )}$ | An n-th AP in a cluster that supports a k-th user (n= 1, 2, ... , Nᵢ ) |
| ${C}_{k} = \{ {AP}_{1}^{( k )} , {AP}_{2}^{( k )} , … , {AP}_{{N}_{i}}^{( k )} \}$ | A set of APs that constitute a cluster supporting a k-th user |
| τ_{c} | A coherence time of a channel |
| Δt | A time interval during which an algorithmic |
| | operation is carried out |
| ${t}_{k}^{d}$ | An allowable delay time until a k-th user's task is completed |
| αₖ | An allocation ratio of computing resources |
| | (clock speed in Hz) to a k-th user |
| hₘₖ | A small-scale channel gain coefficient |
| | between an m-th AP and a k-th user |
| βₘₖ | A large-scale channel fading power between |
| | an m-th AP and a k-th user |
| gₘₖ | A channel gain between an m-th AP and a k-th |
| | user (gₘₖ = \sqrt{βₘₖ} hₘₖ) |
| ηₖ | An uplink power factor of a k-th user |
| ${p}_{k}^{max}$ | Maximum available power of a k-th user terminal |
| pₖ | Power allocated to a k-th user terminal |
| | $( {p}_{k} = {η}_{k} {p}_{k}^{max} )$ |
| W | A channel bandwidth |
| γ_{K} | A signal-to-interference ratio experienced |
| | by a k-th user |
| Rₖ | An uplink transmission rate of a k-th user |
| ${T}_{k} / {T}_{k}^{local} / {T}_{k}^{offload}$ | A workload (bits) of a k-th user/a workload (bits) performed on a terminal/a workload (bits) |
| | performed on a boundary server |
| Rₖ | An uplink transmission rate of a k-th user |
| ${f}_{k}^{max} / {f}_{k}^{local}$ | A maximum possible amount of computing resources allocated to a k-th user (clock speed in |
| | Hz)/an amount of computing resources actually |
| | used for the k-th user's task (Hz) |
| f ^{CPU} | An amount of computing resources provided |
| | by a boundary server of a central processing unit |
| | (clock speed in Hz) |
| ${f}_{k}^{CPU}$ | An amount of computing resources allocated to a k-th user's task by a central processing |
| | unit (clock speed in Hz) |
| ${t}_{k}^{local} / {t}_{k}^{tr} / {t}_{k}^{comp} / {t}_{k}^{offload} / {t}_{k}$ | A task processing delay time at a k-th user terminal/a transmission delay time/a task |
| | processing delay time at a central processing unit/ |
| | a time taken for a task to be processed by a central |
| | processing unit/an actual time taken to process a |
| | task |
| ${E}_{k}^{local} / {E}_{k}^{offload} / {E}_{k}$ | Power consumed for self-computation to process a task of a k-th user terminal/power |
| | unit/actual power consumption |

In FIG. 9, the settings of a cluster model are as follows.

The cluster model has a fixed number (K) of users and a fixed number (M) of access points (APs), and each user is supported by a cluster, which is individually configured by multiple APs (i.e., each user's received symbol is detected by concatenating signals transmitted or received from APs within the cluster). In this case, each user's cluster consists of up to C^{max} APs, and the best AP is selected based on slowly changing channel conditions such as path attenuation and shadowing. In this embodiment, it is assumed that all clusters select the same number of C^{max}.

In FIG. 9, the settings of a channel and transmission rate model are as follows.

A channel gain is determined by large-scale fading and small-scale fading. The small-scale channel fading hₘₖ between an m-th AP and a k-th user has a Rayleigh distribution in a channel size due to a multi-path phenomenon, and the large-scale channel fading βₘₖ between the m-th AP and the k-th user follows path attenuation and shadowing phenomena. Therefore, an overall channel gain gₘₖ between the m-th AP and the k-th user may be modeled as gₘₖ=\sqrt{βₘₖ}hₘₖ.

A signal-to-noise ratio γₖ of the k-th user in FIG. 9 is as follows.

$${γ}_{k} = \frac{{p}_{k} {\vert {\sum }_{m ∈ {C}_{k}} {\hat{g}}_{mk}^{*} {g}_{mk} \vert}^{2}}{{\sum }_{{k}^{′} \neq k} {p}_{{k}^{′}} {\vert {\sum }_{m ∈ {C}_{k}} {\hat{g}}_{mk}^{*} {g}_{{mk}^{′}} \vert}^{2} + {σ}_{m}^{2} {\vert {\sum }_{m ∈ {C}_{k}} {\hat{g}}_{mk} \vert}^{2}}$$

In FIG. 9, an uplink transmission rate of the k-th user is as follows.

$${R}_{k} = \frac{{τ}_{c} - {τ}_{p}}{{τ}_{c}} \cdot W {log}_{2} ( 1 + {γ}_{k} )$$

In FIG. 9, the settings of a processing model for task calculation are as follows.

Each user's terminal has a task that must be calculated within a set time

$$( {t}_{k}^{d} ) ,$$

and the task may be cooperatively processed by the computing resources of the user terminal and the computing resources of the boundary server within a central processing unit connected to a network (i.e., part of the task is processed on the terminal and part thereof is processed on a network according to set criteria in consideration of a battery life of the terminal and a capacity of the computing resources). Among the Tₖ bits of the workload that must be processed by the k-th user, the

$${T}_{k}^{local} bits$$

are calculated at the terminal, and the remaining

$${T}_{k}^{offset} bits$$

are calculated at the boundary server.

The computational power to process the required task is given by a clock speed of the computing resources, and the maximum resource capacity of the k-th user and the boundary server is given as

$${f}_{k}^{max} and {f}^{CPU} ,$$

respectively. Among the resource capacity of

$${f}_{k}^{max} ,$$

the calculations are actually processed on the terminal as a percentage of αₖ and an amount of computing resources allocated to the user terminal is

$${f}_{k}^{local} ( t ) = {α}_{k} ( t ) {f}_{k}^{max} .$$

If a CPU cycle required to process one bit of task is N_{cpb} (cycles), then a number of bits that must be processed at the user terminal to complete the task within a given time is as follows:

$${T}_{k}^{local} ( t ) = min ( {T}_{k} ( t ) , \frac{{t}_{k}^{d} {f}_{k}^{local} ( t )}{{N}_{cpb}} )$$

Accordingly, the actual power consumed may be modeled as follows:

$${E}_{k}^{local} ( t ) = Ϛ {T}_{k}^{local} ( t ) {{N}_{cpb} ( {f}_{k}^{local} ( t ) )}^{2}$$

Meanwhile, a task that cannot be processed on the user terminal within a limited time must be processed by the computing resources of the boundary server on a network side, and the workload is given as

$${T}_{k}^{offload} ( t ) = max ( 0 , {T}_{k} ( t ) - {T}_{k}^{local} ( t ) ) .$$

In this case, in order to offload the workload to the boundary server, an additional delay time occurs due to a transmission rate Rₖ of a current uplink, and the following transmission delay time

$${t}_{k}^{tr}$$

is also taken into consideration along with an actual calculation time.

$${t}_{k}^{tr} ( t ) = \frac{{T}_{k}^{offload} ( t )}{{R}_{k} ( {η}_{k} , t )}$$

In order to process the

$${T}_{k}^{offload} bits$$

offloaded by the k-th user, it takes a time of

$${t}_{k}^{comp} ,$$

which is as follows:

$${t}_{k}^{comp} ( t ) = \frac{{T}_{k}^{offload} ( t ) {N}_{cpb}}{{f}_{k}^{CPU} ( t )}$$

Here,

$${f}_{k}^{CPU} ( t )$$

is an amount of computing resources of the boundary server allocated to the k-th user, and computing resources in proportion to the workload required by K users are distributed as follows:

$${f}_{k}^{CPU} ( t ) = \frac{{T}_{k}^{offload} ( t )}{{\sum }_{k = 1}^{K} {T}_{k}^{offload} ( t )} {f}^{CPU}$$

Therefore, a total time

$${t}_{k}^{offload} ( t )$$

required to offload and process a task of the k-th user is given by a sum of a transmission time

$${t}_{k}^{tr}$$

on the uplink and a computation time

$${t}_{k}^{comp}$$

at the boundary server as follows:

$${t}_{k}^{offload} ( t ) = {t}_{k}^{comp} ( t ) + {t}_{k}^{tr} ( t )$$

The power allocated to the k-th user terminal during the transmission time

$${t}_{k}^{tr}$$

for offloading is

$${p}_{k} ( t ) = {η}_{k} ( t ) {p}_{k}^{max} ,$$

and the energy consumption accordingly is given as follows:

$${E}_{k}^{offload} ( t ) = {p}_{k} ( t ) {t}_{k}^{tr} ( t )$$

Total energy Eₖ consumed by the k-th user is given by a sum of energy used for computation at the user terminal and energy used for transmission for offloading.

$${E}_{k} ( t ) = {E}_{k}^{local} ( t ) + {E}_{k}^{offload} ( t )$$

In FIG. 9, the setup of the offloading problem to minimize energy consumption is as follows.

A resource allocation problem required to satisfy a target delay time until the end of a computational task as a target performance of computing is formalized at a level of the system 10.

Given a task {Qₖ(t)} to be processed for each user and an uplink transmission rate Rₖ, a problem of allocating computing resources and transmission power to maximize energy consumption for all terminals may be formalized as follows:

$$min \text{?} {{\sum }^{K}}_{k = 1} {E}_{k} ( t ) = {{\sum }^{K}}_{k = 1} \text{?} min ( {𝒯}_{k} ( t ) , \text{?} ) N \text{?} + {η}_{k} ( t ) {p}_{k}^{max} \frac{max ( \text{?} )}{\text{?}}$$

$$subject to max ( min ( \frac{min ( {𝒯}_{k} ( t ) \text{?} ) \text{?}}{\text{?}} \text{?} ) \text{?} {𝒯}_{k}^{offload} ( t ) [ \text{?} + \text{?} ] ) \leq {t}_{k}^{d} , ∀ k$$

$$0 \leq \text{?} ( t ) \leq 1 , ∀ k$$

$$0 \leq {η}_{k} ( t ) \leq 1 , ∀ k$$

$$\text{?} \text{indicates text missing or illegible when filed}$$

The experiment of FIG. 9 was carried out based on the variables and environment settings as above, by applying a greedy local algorithm (Greedy Local in FIG. 9), a deep reinforcement learning model without an attention mechanism applied according to an embodiment of FIG. 2 (MADDPG in FIG. 9), and a deep reinforcement learning model with an attention mechanism and root mean square scaling applied according to an embodiment of FIG. 3 (Attn-MADDPG in FIG. 9).

In this case, for a deep reinforcement learning model, M=164, a number of users was fixed to K=10 during training, and a value of K was set between 10 and 15 during inference. Additionally, the large-scale channel model is assumed to be βₘₖ=−30.5−36.7 log₁₀(dₘₖ)+Fₘₖ, where shadow fading is reflected to be Fₘₖ˜ [symbol] (0, 1.6), and a task size of each user is randomly determined with a uniform distribution between 3 Mbps and 9 Mbps values.

Accordingly, referring to FIG. 9, the system 10 based on a deep reinforcement learning model to which an attention mechanism is applied shows a performance that maintains higher or similar performance compared to other methods even when the number of users increases, while at the same time drastically reducing energy consumption. In addition, the system 10 based on a deep reinforcement learning model to which an attention mechanism is applied shows an outstanding performance even in a scenario including 15 users, thereby confirming that it implements a strong generalization ability despite being trained with data targeting 10 users.

According to the foregoing embodiment, the present disclosure may realize resource allocation optimization for implementing cell-free in a mobile edge computing environment, thereby providing an effect of capable of minimizing energy consumption of user terminals and optimizing resource allocation in real time. Through this, a user may maintain stable communication quality while on the move and efficiently process computing tasks while minimizing communication delay.

To this end, a resource allocation method of the present disclosure may be based on deep reinforcement learning (DRL) and a multi-agent deep deterministic policy gradient (MDDPG) algorithm, while applying an attention mechanism thereto to efficiently reflect a status and a resource requirement of each agent, thereby increasing the efficiency of resource distribution as well as maximizing system performance.

Through this, the present disclosure may provide a real-time resource allocation method that can respond to user mobility even in a situation where a plurality of antenna clusters dynamically allocate resources to the user, such as a cell-free based large-scale antenna system.

Such a resource allocation optimization may contribute to improving the user's communication experience and maximizing the resource efficiency of the network, thereby increasing the flexibility of resource allocation under various network conditions and improving the performance of the entire system.

Therefore, the present disclosure may satisfy delay time constraints and energy efficiency required in a next-generation communication system through simultaneous optimization of communication resources and computational resources, and may exhibit very useful technical effects in providing high-quality communication services in a cell-free environment.

It should be understood that various embodiments of the disclosure and terms used herein are not intended to limit the technical features described in the disclosure to specific embodiments, and include various modifications, equivalents, or alternatives of the embodiments. With regard to the description of the drawings, similar reference numerals may be used for similar or related elements. A singular form of a noun corresponding to an item may include one or more of the things, unless the relevant context clearly indicates otherwise.

In the disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Terms such as “1st”, “2nd”, or “first” and “second” may be used merely to differentiate a corresponding element from another, and do not limit the elements in any other aspect (e.g., importance or order). When an element (e.g., a first element) is referred to as being “coupled” or “connected” to another element (e.g., a second element), with or without the term “functionally” or “communicatively,” it means that the element may be connected to the other element directly (e.g., in a wired manner), in a wireless manner, or through a third element.

The term “module” as used in the disclosure may include a unit implemented in hardware, software or firmware, and may be used interchangeably with terms such as logic, logic block, component, or circuit. A module may be an integrally configured component or a minimum unit of the component that performs one or more functions or a part thereof. For example, according to one embodiment, the module may be implemented in a form of an application-specific integrated circuit (ASIC).

Various embodiments of the disclosure may be implemented as software (e.g., a program) including one or more instructions stored in a storage medium (e.g., a memory) that is readable by a device (e.g., an electronic apparatus). The storage medium may include a random access memory (RAM), a memory buffer, a hard drive, a database, an erasable programmable read-only memory (EPROM), an electrically erasable read-only memory (EEPROM), a read-only memory (ROM), and/or the like.

In addition, a processor in embodiments of the disclosure may retrieve at least one instruction from among one or more instructions stored from a storage medium and execute the retrieved instruction. This allows the device to operate to perform at least one function according to the retrieved at least one instruction. The one or more instructions may include a code generated by a compiler or a code executable by an interpreter. The processor may be a general purpose processor, a field programmable gate array (FPGA), an application specific integrated circuit (ASIC), a digital signal processor (DSP), and/or the like.

The device-readable storage medium may be provided in a form of a non-transitory storage medium. Here, the term ‘non-transitory’ simply means that the storage medium is a tangible apparatus and does not include a signal (e.g. electromagnetic waves), and this term does not differentiate between a case where data is stored semi-permanently and a case where the data is temporarily on the storage medium.

A method according to various embodiments disclosed in the disclosure may be included and provided in a computer program product. The computer program product may be traded as a commodity between a seller and a buyer. The computer program product may be distributed in a form of a device-readable storage medium (e.g., compact disc read only memory (CD-ROM)), or be distributed (e.g., downloaded or uploaded) online via an application store (e.g., PlayStore) or directly between two user apparatuses (e.g., smartphones). In the case of online distribution, at least part of the computer program product may be at least temporarily stored or temporarily generated in the device-readable storage medium, such as a manufacturer's server, a server of an application store, or a server's memory.

According to various embodiments, each element (e.g., a module or a program) of the above-described elements may include a single entity or a plurality of entities. According to various embodiments, one or more of the aforementioned elements or operations may be omitted, or one or more other elements or operations may be added. Alternatively or additionally, the plurality of elements (e.g., modules or programs) may be integrated into a single element. In such a case, the integrated element may perform one or more functions of each of the plurality of elements in the same or similar manner to those performed by a corresponding one of the plurality of elements prior to the integration. According to various embodiments, operations performed by a module, a program or another element may be executed sequentially, in parallel, repeatedly, or heuristically, or one or more of the operations may be executed in a different order, omitted, or one or more other operations may be added.

### DESCRIPTION OF SYMBOLS

10: Resource allocation system
100: User terminal (local agent)
100: Edge Server
110: Memory
120: Processor
130: Input/output interface
140: Communication interface

What is claimed is:

1. A resource allocation system based on a multi-agent based deep reinforcement learning model using an attention mechanism in a mobile edge computing environment,
wherein the deep reinforcement learning model comprises an actor network learned to determine an action to perform based on state information of the mobile edge computing environment and a critic network learned to determine a Q value representing a total expected value of a reward according to the action,
wherein the system comprises:
a user terminal that operates as a local agent that determines an action in a direction of maximizing a Q value based on state information given based on the actor network, and transmits the determined action to an edge server to share with the critic network; and
an edge server that derives a Q value according to the action of each user terminal based on the critic network to transmit the derived Q value to each user terminal, and
wherein the critic network comprises an attention layer that generates an output value reflecting a weight according to a similarity between information of any one user terminal and information of another user terminal based on Key, Query, and Value values set according to the attention mechanism, and determines a Q value based on an output value of the attention layer.

2. The system of claim 1, wherein the edge server collects state information on the mobile edge computing environment, generates state information for each user terminal, and transmits the generated state information to each user terminal, and
wherein the user terminal determines an action based on state information acquired from the edge server, and transmits the state information and the determined action information to the edge server to share with all critic networks.

3. The system of claim 1, wherein the action is set to a workload to be allocated to each user terminal according to given state information and uplink transmission power to be allocated to each user terminal according to the given state information, and
wherein the reward is set as a reward in proportion to a total power saving amount of the user terminal.

4. The system of claim 1, wherein the edge server stores each critic network that operates in response to each actor network distributed to each user terminal.

5. The system of claim 4, wherein an attention layer of a k-th critic network that operates in response to an actor network of a k-th user terminal (k is a natural number greater than or equal to 1 and less than or equal to K), which is any one of K (a total number of user terminals) user terminals, comprises:
Kᵢ(t)=f_{K}(oᵢ(t), aᵢ(t)), which is an encoding function that derives a Key value by other user terminals except the k-th user terminal among the K user terminals (Kᵢ(t) is the Key value, f_{K} is an encoding function that determines the Key value, is state information of another user terminal at a t-th time point, and aᵢ(t) is an action of another user terminal at the t-th time point);
Qₖ(t)=f_{Q}(oₖ(t), aₖ(t)), which is an encoding function that derives a Query value by the k-th user terminal (Qₖ(t) is the Query value, f_{Q} is an encoding function that determines the Query value, oₖ(t) is k-th state information of the k-th user terminal at the t-th time point, and aₖ(t) is an action of the k-th user terminal at the t-th time point);
Vᵢ(t)=f_{V}(oᵢ(t), aᵢ(t)), which is an encoding function that derives a Value value from another user terminal (Vᵢ(t) is the Value value by another user terminal, f_{V} is an encoding function that determines the Value value, oᵢ(t) is state information of another user terminal at the t-th time point, and aₖ(t) is an action of another user terminal at the t-th time point); and
Vₖ(t)=f_{V}(oₖ(t), aₖ(t)), which is an encoding function that derives a Value value by the k-th user terminal (Vₖ(t) is the Value value by the k-th user terminal, f_{V} is an encoding function that determines the Value value, oₖ(t) is state information of the k-th user terminal at the t-th time point, and aₖ(t) an action of the k-th user terminal at the t-th time point), and
wherein an output value that reflects a weight according to a similarity between information Qₖ(t) and Vₖ(t) on the k-th user terminal and information Kᵢ(t) and Vᵢ(t) on another user terminal is generated.

6. The system of claim 5, wherein the attention layer of the k-th critic network comprises:
a first matrix multiplication layer that derives Qₖ(t)Kᵢ^{T}(t), which is an inner product of the Kᵢ(t) and the Qₖ(t);
a scaling layer that derives either one of
$$\frac{{Q}_{k} ( t ) {K}_{i}^{T} ( t )}{\sqrt{\overline{{Q}_{k} ( t ) {K}_{i}^{T} ( t )}}} ( \overline{{Q}_{k} ( t ) {K}_{i}^{T} ( t )}$$
is a mean value of an inner product of Qₖ(t) and Kᵢ(t)) and
$$\frac{{Q}_{k} ( t ) {K}_{i}^{T} ( t )}{{d}_{inp} \sqrt{d}}$$
(dᵢₙₚ is a size of an outer dimension of a state-action input value or input embeddings represented as a tensor) that scales the
$${Q}_{k} ( t ) {K}_{i}^{T} ( t )$$
by a square root
$$\sqrt{\overline{{Q}_{k} ( t ) {K}_{i}^{T} ( t )}}$$
of a mean for an inner product of the Kᵢ(t) and the Qₖ(t);
a softmax layer that inputs the normalization value into a softmax function to output either one of
$${α}_{k , i} ( t ) = Softmax ( \frac{{Q}_{k} ( t ) {K}_{i}^{T} ( t )}{\sqrt{\overline{{Q}_{k} ( t ) {K}_{i}^{T} ( t )}}} ) and {α}_{k , i} ( t ) = Softmax ( \frac{{Q}_{k} ( t ) {K}_{i}^{T} ( t )}{{d}_{inp} \sqrt{d}} ) ;$$
a second matrix multiplication layer that derives cₖ, which is an inner product of the α_{k,i}(t) and the Vᵢ(t); and
a connection layer that generates a concatenated vector acquired by concatenating cₖ and the Vᵢ(t) according to a predetermined concatenation algorithm, and
wherein the critic network determines a Q value, which is a total expected value of a reward according to an action of the k-th user terminal based on the concatenated vector.

7. The system of claim 1, wherein the edge server additionally stores an extra actor network for a user terminal to be newly added to its service cluster, and transmits, when there is a user terminal newly added to its service cluster, the extra actor network to the newly added user terminal, and
wherein the added user terminal determines an action in a direction of maximizing a Q value according to state information given from the cluster using the extra actor network.

8. The system of claim 1, wherein the edge server is configured with a main network comprising a first actor network and a first critic network based on deep reinforcement learning, and a target network comprising a second actor network and a second critic network having the same neural network structure as the main network to learn the main network and the target network based on a multi-agent deep deterministic policy gradient (MDDPG) learning algorithm through the same learning data, and learn the parameters of the main network and the parameters of the target network at different speeds so as to generate the deep reinforcement learning model.

9. The system of claim 8, wherein the edge server reflects a parameter value of
$${τθ}_{k}^{μ} + ( 1 - τ ) {θ}_{k}^{{μ}^{′}}$$
$$( {θ}_{k}^{μ}$$
is a learning parameter of the first actor network,
$${θ}_{k}^{{μ}^{′}}$$
is a learning parameter of the second actor network, and τ is a constant that sets an update rate of the two actor network parameters) to the second actor network, and
reflects a parameter value of
$${τθ}_{k}^{Q} + ( 1 - τ ) {θ}_{k}^{{Q}^{′}}$$
$$( {θ}_{k}^{Q}$$
is a learning parameter of the first critic network,
$${θ}_{k}^{{Q}^{′}}$$
is a learning parameter of the second critic network, and τ is a constant that sets an update rate of the two critic network parameters) to the second critic network.

10. A method of operating a resource allocation system based on deep reinforcement learning model using an attention mechanism in a mobile edge computing environment,
wherein the deep reinforcement learning model comprises an actor network learned to determine an action to perform based on state information of the mobile edge computing environment and a critic network learned to determine a Q value representing a total expected value of a reward according to the action,
wherein the method comprises:
an operation of determining, by the user terminal as a local agent, an action in a direction of maximizing a Q value according to state information given based on the actor network; and
an operation of deriving, by the edge server, a Q value according to the action of each user terminal based on the critic network to transmit the derived Q value to each user terminal, and
wherein the critic network comprises an attention layer that generates an output value reflecting a weight according to a similarity between information of any one user terminal and information of another user terminal based on Query, Key, and Value values set according to an attention mechanism, and determines a Q value based on the output value of the attention layer.
